(19) United States
(12) Patent Application Publication
(10) Pub. No.: US 2011/0006482 A1
(43) Pub. Date: Jan. 13, 2011

(54) SEALING MEANS

(76) Inventors: Keith Jones, Greater Manchester (GB); Thomas John Pritt, Cumbria (GB); Stuart Geoffrey Pegler, Cumbria (GB); Kristian Alan Royle, Cumbria (GB)

Correspondence Address: LADAS & PARRY LLP, 224 SOUTH MICHIGAN AVENUE, SUITE 1600, CHICAGO, IL, 60604, US

(21) Appl. No.: 12/933,464

(22) PCT Filed: Mar. 25, 2009
(86) PCT No.: PCT/GB09/50289

§ 371 Date: Sep. 20, 2010

(30) Foreign Application Priority Data
Mar. 25, 2008 (GB) 0805335.7

(51) Int. Cl. F16L 55/128

(52) U.S. Cl. 277/314

(57) ABSTRACT

The invention concerns a method of providing a seal within a pipe or aperture in a vessel and preventing fluid flow therethrough, the method comprising: (a) providing a non-porous, expandable, flexible container within said pipe or aperture; (b) introducing an expandable polymeric material into said container so as to expand said container, thereby forcing said container to fill the cross-sectional area of said pipe or aperture and displacing any fluid in said pipe or aperture in order to provide an engineered blockage within said pipe or aperture; (c) applying a bonding resin between the external surfaces of said container and the internal surfaces of the walls of said pipe or aperture; and (d) curing said expandable polymeric material and bonding resin so as to bond the expanded container to the pipe or aperture and create a seal between the outer surfaces of said container and the internal surfaces of the walls of said pipe or aperture. The method finds particular application in the prevention aqueous liquid flow through pipework and in environments contaminated with radioactivity. It is simple and cost effective to employ.

### FIELD OF THE INVENTION

This invention relates to means for sealing passages so as to prevent flow of fluid therethrough and, more specifically, provides an expandable bag which fills the cross-section of the passage, and is bonded to the inner surfaces thereof, so as to prevent leakage.

### BACKGROUND TO THE INVENTION

There is frequently a requirement for closing off or sealing flow passages which are no longer required or desired, or which may necessitate sealing for safety or other reasons. It then becomes necessary to effectively prevent fluid flow through such passages, which may typically comprise such examples as pipework used in industrial plants, or underground facilities conduits, such as gas or water mains. The present invention is particularly directed towards passages which convey liquids, most particularly aqueous liquids.

Various methods for sealing pipework and passages are known from the prior art, many of these being based on the use of expandable compositions to effectively create a blockage. Thus, for example, in GB-A-2123919 a pipe is sealed by forming therein a resiliently deformable seal. In one example, a new service pipe is passed inside an existing pipe, a branch pipe is broken away and an injection gun is used to inject a sealant material through the opening so formed to form a resiliently deformable annular seal upstream of the branch. In a preferred embodiment, the sealant material expands to a closed cell polyurethane foam.

The use of expandable bags for the sealing of passages has also been discussed in the prior art. In GB-A-2157390 there is disclosed an apparatus and method wherein a flow passage is stopped by insertion of a porous bag which is then inflated with a sealant composition (e.g. polyurethane foam), some of which seeps out and seals to the passage wall.

GB-A-2226855 teaches a sealant applicator for closing off flow passages by pumping expanding foam compositions into pipes. The system involves placing a sachet containing a sealant composition in a cylinder and forcing the sachet by a piston against an end wall having an outlet and a cutter, so that the sachet is ruptured and the composition is expelled through the outlet. Sachets may contain a two-component expandable composition with the components separated by a partition which can be ruptured so that the components can be mixed and start to expand before the (externally intact) sachet is placed in the cylinder.

Subsequently, GB-A-2432642 has reported a method for closing off a conduit with an expandable foam sealant wherein an elongate bag, dimensioned to fit fairly snugly into the conduit, receives a sachet of expandable, settable, foam composition, preferably in an openable compartment. Expansion of the foam urges the sachet against a cutter that is present within the bag, rupturing it. Thereafter, the expanding foam may pass through a partition into a further compartment, which becomes filled. A minor proportion of the foam escapes through the porous or semi-porous cylindrical wall of the bag, thereby sealing it to a wall of the conduit.

These techniques of the prior art have been successfully applied to a variety of situations wherein passages, conduits or pipework have required sealing. In all cases, however, these systems rely on the use of expandable foam as both the blocking material, forming the physical obstacle across the cross-section of the channel, and the bonding agent, forming the seal with the internal surfaces of the channel. Typically, therefore, the methods have relied on the seepage of expandable foam through porous or semi-porous bags in order to create the blockage.

Whilst this general technique is frequently satisfactory, it does have the disadvantage that it cannot be utilised in situations where liquids are present in the pipes and, as a consequence, there is a requirement in such situations for the liquid present on the environment to be completely evacuated in the light of the adverse reaction of the expanding foam when in contact with liquids. Most specifically, it is known that these systems are not water tolerant. Consequently, the present inventors have sought to address this deficiency in the prior art, and to provide a system which is effective in sealing passages so as to prevent flow of fluid therethrough, and which can be successfully deployed in the presence of the fluid concerned. Most particularly, the method of the present invention addresses the problems associated with the sealing of passages through which liquids, most particularly aqueous liquids, are flowing, and allows for these seals to be inserted in the presence of such liquids, and without the need for their removal from the environment.

### SUMMARY OF THE INVENTION

Thus, according to the present invention, there is provided a method of providing a seal within a pipe or aperture in a vessel and preventing fluid flow therethrough, said method comprising:
(a) providing a non-porous, expandable, flexible container within said pipe or aperture;
(b) introducing an expandable polymeric material into said container so as to expand said container, thereby forcing said container to fill the cross-sectional area of said pipe or aperture and displacing any fluid in said pipe or aperture in order to provide an engineered blockage within said pipe or aperture;
(c) applying a bonding resin between the external surfaces of said container and the internal surfaces of the walls of said pipe or aperture; and
(d) curing said expandable polymeric material and bonding resin so as to bond the expanded container to the pipe or aperture and create a seal between the outer surfaces of said container and the internal surfaces of the walls of said pipe or aperture.

The method finds particular application in the prevention of liquid flow, particularly aqueous liquid flow, through pipes or apertures, and is especially successfully applied to the prevention of fluid flow through pipework and circumferential apertures in vessels. The technique may be utilised for the sealing of pipework having a diameter of up to at least 60 cm (2 feet), but is especially successfully applied to pipework having a diameter in the range of from 2.5 cm to 30 cm (1 inch to 1 foot), and most particularly in the range of from 5 cm to 25 cm (2 inches to 10 inches).

Preferably, said non-porous, expandable, flexible container comprises a flexible non-porous bag comprised of a polymeric material, most preferably a bag comprised of a plastic material, particularly a thermoplastic material. Suitable thermoplastic materials include, for example, polyethylene or nylon.

The container is selected to be of a suitable size such that, in its expanded form, it is of sufficient dimensions to form a complete blockage across the entire cross-section of the pipe or aperture. Thus, in the most preferred embodiment of the invention, a bag having sufficient dimensions in its expanded form to provide a complete blockage of a given pipe or aperture could readily be selected by a skilled person.

The container is placed either manually or remotely, at the appropriate location in the pipe or aperture where it is intended to create the blockage. The container may either be introduced by being passed from one end of the pipe or aperture to the chosen location, or an incision in the pipe or aperture may be created at the chosen location to allow the container to be introduced at that location.

The bag must be suitably robust to withstand the procedure of deployment into the pipe or aperture and the conditions which are likely to be encountered thereafter and, in this context, must display very high tear resistance. Furthermore, the bag must be comprised of a material which has a low enough coefficient of friction to allow it to be easily deployed in the particular pipe or aperture.

The expandable polymeric material is preferably provided in the form of a foam, most preferably a polyurethane foam. Said foam is typically introduced into said container, after location of the container at the desired position within the pipe or aperture, by pumping under pressure until the container is completely filled, such that its outer surfaces are pressed into intimate contact with the internal surfaces of the walls of the pipe or aperture. Alternatively, said foam may be provided by means of a pre-foam composition, introduced into said container prior to location of the container at the desired position within the pipe or aperture, said composition comprising components which are selected so as to inter-react and generate foam after a predetermined period of time, typically in the region of 5 minutes. In either embodiment, the period of time taken for the foam to expand fully into the cross-section of the pipe or aperture is typically in the region of 15 minutes.

The bonding resin is applied to the outer surfaces of the container so as to firmly adhere these surfaces to the inner surfaces of the walls of the pipe or aperture. Typical bonding resins may include any of those readily available commercially, such as acrylate bonding resins and the like.

The preferred method of application of said bonding resin is generally determined according to the diameter of the pipe or aperture which is to be sealed. Thus, for pipes or apertures having a diameter of less than about 20 cm (8 inches), it is preferred that said bonding resin should be applied manually to the outer surfaces of said container prior to the introduction of said container into said pipe or aperture.

In a preferred embodiment of the invention, the bonding resin may be applied to one or more circumferential rings located on the outer surface of the container. Preferably, the number of circumferential rings is between 1 and 5, more preferably between 2 and 4. Preferably, the circumferential rings are comprised of the same material as the container, and are porous, thereby allowing bonding resin to be retained within their pores whilst the container is deployed into position. Thereafter, as a consequence of the porous nature of the circumferential ring material, typically achieved by the inclusion of a multiplicity of small holes in the surface thereof, the resin is allowed to pass through the material when the empty container is pressurised by the introduction of the expandable polymeric material, thus allowing it to contact the internal pipe or aperture wall and thereby create a bond.

However, with pipes or apertures whose diameter is 20 cm (8 inches) or more, superior results are achieved by application of said bonding resin after positioning of said container in said pipe or aperture and expansion of said container by means of said expandable polymeric material. Typically, said bonding resin may be applied in such situations by, for example, injection between said surfaces of said container and said pipe or aperture. In such embodiments, this interspace comprises an annulus which is filled with resin after the expanding polymeric material has formed the container against the internal wall of the pipe or aperture.

In each of these alternative embodiments of the bonding operation, an effective seal may be completed without the need to evacuate liquid from the environment where the seals are required.

Curing of said expandable polymeric material and said bonding resin, so as to ensure that the container remains fully inflated and that the expanded container is firmly sealed to the pipe or aperture, thereby creating a seal between the outer surfaces of said container and the internal surfaces of the walls of said pipe or aperture, is allowed to occur over a period of time. The selection of expandable polymeric materials and bonding resins is influenced by the requirement that said curing operation should take place over a reasonable timescale. The curing time is also temperature dependent.

In preferred embodiments of the present invention, curing is allowed to take place at ambient temperature. Generally, under such conditions, curing of the expandable polymeric material is expected to be complete after a period of about 30 minutes to 1 hour, whilst curing of the bonding resin should be complete after around 72 hours.

The method of the invention finds application in a wide range of situations, such as the sealing of underground utility mains, drains and pipework in industrial plants.

Particularly advantageous results have been achieved when applying the technique in order to seal process links from waste settling tanks, especially waste settling tanks containing radioactive waste. In such circumstances, it is necessary that the container which is deployed according to the method of the invention, the expandable polymeric material contained therein, and the bonding resin should all be radiation tolerant. In such circumstances, suitable materials for the container would include polyethylene and nylon, suitable expandable polymeric materials could be, for example, polyurethane foams, and suitable bonding resins may include acrylic resins.

In operation, the satisfactory performance of the method of the invention is enhanced by the use of various access and observation means, according to the particular situation which is being addressed. Thus, the performance of the method of the invention frequently involves the use of accessories such as scaffolding, CCTV equipment, and cleaning equipment, such as jet-washing devices.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

The method of the present invention will now be further illustrated, though without in any way limiting its scope, by reference to the accompanying drawings, wherein:

FIG. 1 shows a seal after deployment according to the method of the invention in pipework of 10 or 15 cm (4 or 6 inch) diameter, wherein the bonding resin is applied to the outer surface of the container before insertion of the container in the pipework;

FIG. 2 shows a seal after deployment according to the method of the invention in pipework of 20 cm (8 inch) diameter, wherein the bonding resin is applied between the outer surface of the container and the inner surface of the walls of the pipework after insertion of the container in the pipework;

FIG. 3 shows a practical structural arrangement incorporating scaffolding and lifting equipment, designed to allow for the deployment of seals according to the method of the invention in pipework which is attached to a storage tank; and

FIG. 4 shows a seal correctly positioned in pipework following deployment according to the method of the invention.

### DESCRIPTION OF THE INVENTION

The method of the invention relies on the deployment of a non-porous container in a pipe or aperture which is to be sealed. Preferably, the container is remotely deployed into the pipe or aperture to be sealed. Once correctly positioned within the pipe or aperture, the container becomes filled with suitable expanding polymeric material, preferably polyurethane foam. The expanding foam causes the container to fill the pipe or aperture cross-sectional area, thereby displacing any fluid in the pipe or aperture and providing an engineered blockage. A bonding resin, deployed between the foam filled container and the pipe, seals the expanded container to the pipe or aperture. Once the resin and the expanding foam have cured, the sealing of the pipe or aperture is completed. The container is formed from a thermoplastic, which is preferably tolerant to radiation with a dose rate typically of the order of 1 Sv/hr, which is equivalent to an absorbed dose of 9×10 exp3 Gy/year. Examples of suitable thermoplastics include polyethylene and nylon. The expected lifetime of the seal, once deployed, is of the order of 8-10 years.

In a specific circumstance addressed by the present inventors, a contaminated pond was presenting a significant hazardous radiological environment, since the facility held quantities of Magnox sludge and miscellaneous debris, as well as discarded building fabric. Redundant building process links to an adjacent facility which contained a redundant sludge settling tank presented an additional hazard, since there was a risk of uncontrolled flow of supernatant liquor from the pond to the tank, via the process links. It was concluded that the most appropriate means of mitigating this risk of flow was to provide a seal at the entry points of the process links into the tank, and this situation was successfully addressed by the application of the method of the present invention and provides a convenient illustration of the method of the invention, which is further enhanced by reference to the accompanying drawings.

Thus, there were 3 process links between the redundant sludge settling tank and the contaminated pond, these links comprising pipes having diameters of 20 cm (8 inches), 15 cm (6 inches) and 10 cm (4 inches). The 20 cm diameter outlet entered into the tank approximately 4.5 metres below pond surface, whilst the 10 cm and 15 cm outlets entered into the tank approximately 6.5 metres below the pond surface, and access was only possible from staging located directly adjacent the tanks.

The varying pipe diameters in the situation that was addressed necessitated the application of different embodiments of the method of the invention, involving the use of the different methods of application of the boding resin. Thus, for the pipes having a diameter of 10 cm and 15 cm, the bonding resin was applied manually to the outer surfaces of the container prior to the introduction of the container into the pipe, whilst with the 20 cm diameter pipe, the bonding resin was applied after positioning of the container in the pipe and expansion of the container by introduction of an expandable polymeric material.

Referring firstly to FIG. 1, it is shown that for each of the 10 cm and 15 cm pipes, an epoxy bonding resin 1 was applied manually to a container comprising an empty bag before deployment of the bag 2 in the pipe 3. The resin was applied to three circumferential rings made of porous material situated on the outer surface of the empty bag and, after deployment and positioning of the bag 2, expanding foam 4 was injected via foam delivery hose 5 through delatch coupling 6 into the empty bag, forcing the resin rings 1 onto the inner surfaces 7 of the pipe 3. Thus, the bonding resin held in position in the porous circumferential rings located on the surface of the bag during deployment was caused to pass through the porous material of these rings when the empty bag was pressurised by the introduction of the expanding foam, thus allowing it to contact the pipe wall and thereby create a bond.

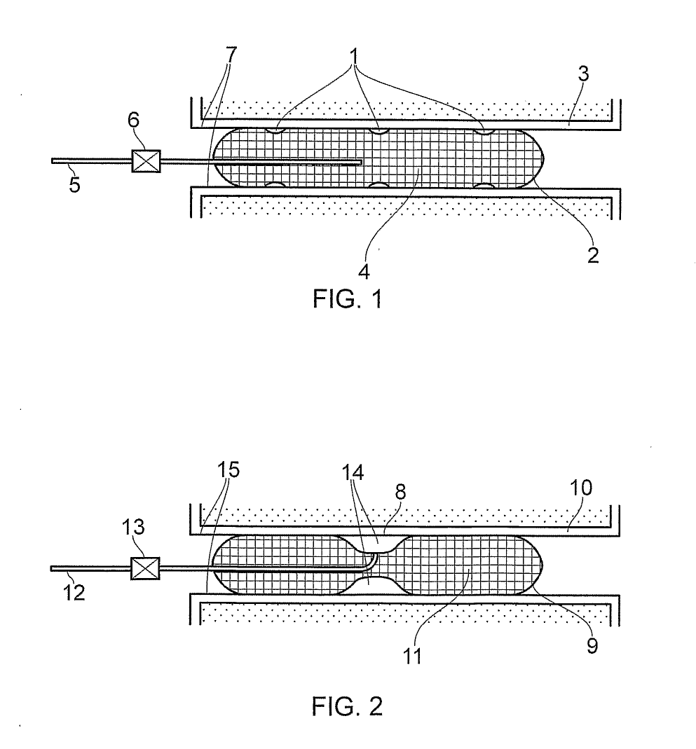

In the case of the 20 cm pipe, as illustrated in FIG. 2, the bonding resin 8 was applied after deployment and positioning of the bag 9 within the pipe 10, and after introduction of the expanding foam 11. The bonding resin was injected via resin delivery hose 12 through delatch coupling 13 into an inter space 14 within a central section of the seal. This inter space comprised an annulus which was filled with resin 8 after the expanding foam had formed the bag against the inner surfaces 15 of the pipe 10.

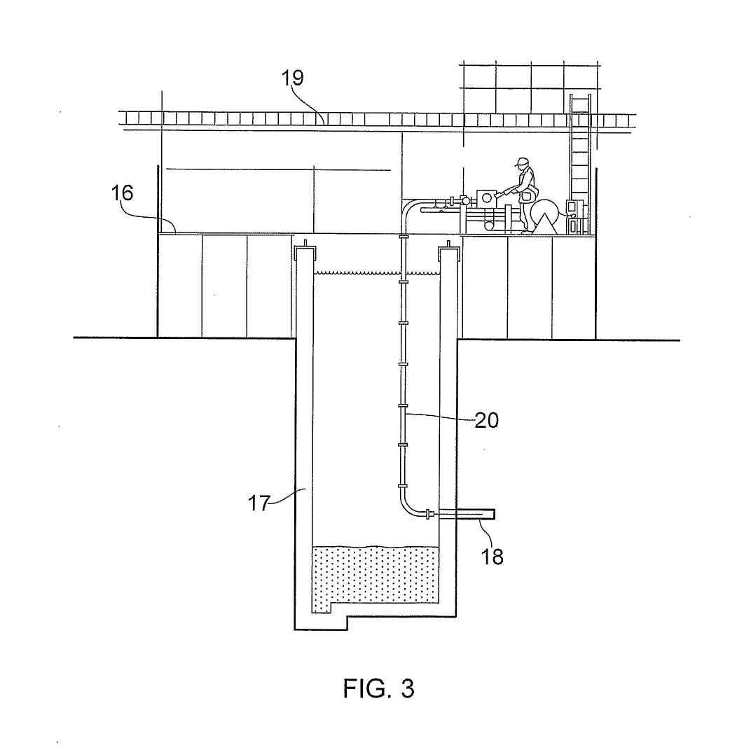

In operation in this environment, the seals were manually installed from a specifically installed load bearing scaffold structure (staging platform) 16 erected above the tank 17 containing the pipes 18 to be sealed as seen in FIG. 3. The load bearing scaffold incorporated lifting beams 19 and trolleys to aid the equipment installation sequence, with injection of expandable foam and resin being effected via delivery tube 20.

In order to implement an effective seal, each pipe required suitable access provision, together with visual inspection and cleaning (removal of sludge, algae growth, corrosion), prior to seal installation using the method of the invention. All the operations were undertaken via a pipe conduit (delivery tube) which routed and guided all equipment requirements from the staging platform to the pipe to be sealed.

The delivery tube was of modular design and was supported from a deployment frame which was mounted on the scaffold platform above the pipe to be sealed. Modular sections of the pipe conduit were singly installed onto the deployment frame until the bottom end was aligned with the relevant pipe. The deployment frame incorporated X-Y-Z adjustment features to ensure accurate alignment of the delivery tube with the pipe. The deployment frame also incorporated a wash facility to wash down all plant and equipment on its retraction from the delivery tube.

Initially, the pipe internals were visually inspected by insertion of a camera to the pipe via the delivery tube. This was followed by a pipe cleaning operation, using conventional pipe cleaning methods incorporating a jetting head on the end of a high pressure water hose. Once the pipe was sufficiently clean, the seal was installed.

In the case of the 10 cm and 15 cm pipes, the empty container, in the form of a bag, was installed onto the end of the foam injection hose using a delatch connector. Three circumferential rings on the outer surface of the evacuated bag were then filled with epoxy resin by injection. These rings were perforated in order to allow the resin to pass through later in the procedure. The bag was then manually fed down the deployment tube using the foam injection hose to push it through, with markers positioned on the hose system being used to indicate that the bag was installed to the desired position. The positioning of the bag was confirmed by means of CCTV, with minor adjustments being made, as appropriate.

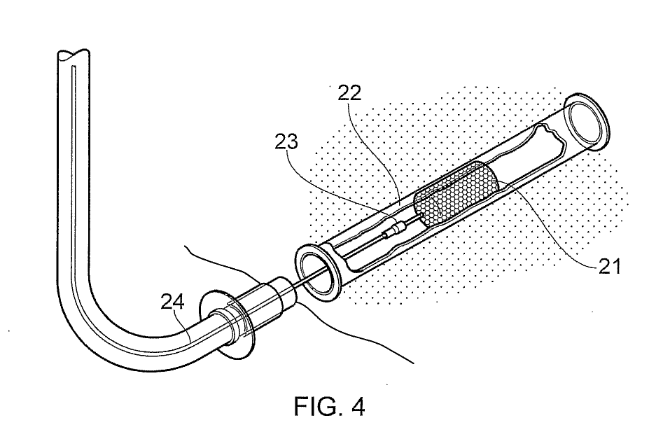

Following confirmation of the correct location, a prescribed quantity of expanding polyurethane foam was injected into the empty bag, which was thereby expanded so as to take up the shape of the pipe, as shown in FIG. 4. As a consequence of the expansion of the bag 21, the resin rings were compressed onto the inner surface of the cleaned pipe 22. This process also displaced water from the area of the seal. After visual confirmation that the bag had expanded satisfactorily, a delatch system 23 was actuated from the working platform in order to release the hose feed pipework 24 from the newly installed seal. Following completion of the seal installation, the deployment equipment was dismantled and removed.

Deployment of a seal in the case of the 20 cm pipe involved initial installation of the container, in the form of a bag, onto the end of the resin injection hose using a delatch connector. A ruptured premixed sachet of pre-expanded foam was then inserted into the bag, which was sealed by means of a quick fastening technique utilising a polymer zip. The bag was then manually fed down the delivery tube using the resin injection hose to push it through. Markers positioned on the hose system indicated when the bag was installed to the desired position, and this was confirmed by means of CCTV, with minor adjustments being made, as appropriate.

After approximately 30-minutes the pre-installed sachet of foam expanded the bag into the pipe. Following visual confirmation from the CCTV that the bag had expanded, a prescribed quantity of bonding resin was injected to the seal. The resin was directed to an interspace between the bag and the pipe inner surface located halfway along the length of the seal, as shown in FIG. 2. The resin forced any residual water deposits out of this interspace, and completed an annular seal between the bag and the pipe inner surface. On completion of this process, the delatch system was actuated from the working platform, so as to release the hose feed pipe work from the newly installed seal. Following completion of the seal installation, the deployment equipment was dismantled and removed.

The general procedure applied to the 10 cm and 15 cm pipes may be conveniently gleaned from Table 1.

TABLE 1
Application of the Sealing Method to Pipes of 10 cm and 15 cm Diameter

| Pipe Diameter | Seal Construction | Method of Installation |
|---|---|---|
| 10 cm (4 inch) | Two part foam provided in | Two part resin mixed and poured |
| or | separate large plastic tubs | into syringe cartridge |
| 15 cm (6 inch) | Two part resin provided in | Resin injected into outer rings/ |
| | separate small plastic tubs | bands using hand powered syringe |
| | Inner core - polyurethane foam, | Bag deployed through delivery |
| | cylindrical shape, Ø4” OD¹ or Ø6” | tube into position |
| | OD², approx 500 mm long | Two part foam mixed and poured |
| | Outer rings - resin, three rings | into Mk 1 long distance pump |
| | approx 15 mm thickness | Foam injected into bag using Mk 1 |
| | Bag material - non-permeable | long distance pump |
| | white 4 oz Nylon | Umbilical hose delatched from bag |
| | Hose connection - 14 mm ID | and retracted |
| | Nylon hose, crimp fittings, quick | Foam allowed to cure. |
| | release delatch connection | |

¹Ø4” OD refers to the container (bag) which is used to seal the 10 cm pipe.
²Ø6” OD refers to the container (bag) which is used to seal the 15 cm pipe.

The method of the invention as hereinbefore described shows significant advantages over the methods available from the prior art. As previously observed, there is no necessity for liquid to be evacuated from the system prior to deployment of the seal, and this provides the additional benefits of a simple deployment system, and reduced requirement for safety and design constraints as a consequence of less pressure head within the process link, the existing pipework maintaining the quiescent state of plant.

In addition, the following advantages are also associated with the method of the invention:
Reduced costs associated with simple implementation hardware and simple implementation methodology;
Reduced timescale in implementation, in view of the less complex system and fewer operations involves;
Improved safety features, in terms of reduced risk to implementation personnel from a conventional health and safety perspective and, when implemented in systems which feature radioactivity, lower radiological exposure is associated with seal implementation;
Fault sequences associated with seal implementation are minimised; and
Engineering Integrity is improved, the seal deployed according to the method of the invention offering a more robust solution, in that it provides multiple sealing sites, and therefore multiple barriers against failure.

The method of the invention finds potential application in a wide variety of applications, including the following:
Isolation of wet pipelines in general (in both nuclear and non-nuclear applications);
Flow restriction of gaseous product pipelines;
Isolation of lines entering vessels; and
Emergency isolation of pipelines.
Isolation in dry pipelines (in both nuclear and non-nuclear applications).

1.-33. (canceled)

34. A method of providing a seal within a pipe or aperture in a vessel and preventing fluid flow therethrough, said method comprising:
(a) providing a non-porous, expandable, flexible container within said pipe or aperture;
(b) introducing an expandable polymeric material into said container so as to expand said container, thereby forcing said container to fill the cross-sectional area of said pipe or aperture and displacing any fluid in said pipe or aperture in order to provide an engineered blockage within said pipe or aperture;
(c) applying a bonding resin between the external surfaces of said container and the internal surfaces of the walls of said pipe or aperture; and
(d) curing said expandable polymeric material and bonding resin so as to bond the expanded container to the pipe or aperture and create a seal between the outer surfaces of said container and the internal surfaces of the walls of said pipe or aperture.

35. A method as claimed in claim 34 for use in the prevention of liquid flow, wherein said liquid optionally comprises an aqueous liquid.

36. A method as claimed in claim 34 wherein said pipe or aperture comprises pipework having a diameter in the range of from 2.5 cm to 60 cm (1 inch to 2 feet).

37. A method as claimed in claim 34 wherein the non-porous, expandable, flexible container comprises a flexible non-porous bag comprised of a polymeric material.

38. A method as claimed in claim 37 wherein said polymeric material comprises a thermoplastic material and said thermoplastic material optionally comprises polyethylene or nylon.

39. A method as claimed in claim 34 wherein said container is placed manually or remotely at the location in the pipe or aperture where it is to create the blockage.

40. A method as claimed in claim 34 wherein said expandable polymeric material comprises a foam, and wherein said foam optionally comprises a polyurethane foam.

41. A method as claimed in claim 40 wherein said foam is introduced into said container after location of the container at the desired position within the pipe or aperture by pumping under pressure until the container is completely filled.

42. A method as claimed in claim 40 wherein said foam is provided by means of a pre-foam composition, introduced into said container prior to location of the container at the desired position within the pipe or aperture, said composition comprising components which are selected so as to inter-react and generate foam after a predetermined period of time.

43. A method as claimed in claim 34 wherein said bonding resin is applied to the outer surfaces of the container so as to firmly adhere these surfaces to the inner surfaces of the walls of the pipe or aperture.

44. A method as claimed in claim 34 wherein said bonding resin comprises an acrylate bonding resin.

45. A method as claimed in claim 34 wherein said pipe or aperture has a diameter of less than about 20 cm (8 inches) and said bonding resin is applied manually to the outer surfaces of said container prior to the introduction of said container into said pipe or aperture.

46. A method as claimed in claim 45 wherein said bonding resin is applied to one or more circumferential rings located on the outer surface of the container, wherein the number of said circumferential rings is optionally between 1 and 5, and wherein the material of the circumferential rings is optionally porous.

47. A method as claimed in claim 34 wherein said pipe or aperture has a diameter of 20 cm (8 inches) or more and said bonding resin is applied after positioning of said container in said pipe or aperture and expansion of said container by means of said expandable polymeric material.

48. A method as claimed in claim 47 wherein said bonding resin is applied by injection between said surfaces of said container and said pipe or aperture.

49. A method as claimed in claim 34 wherein curing of said expandable polymeric material and said bonding resin is allowed to occur at ambient temperatures over a period of time, wherein the period of time for curing of said expandable polymeric material is optionally from 30 minutes to 1 hour and wherein the period of time for curing of said bonding resin is optionally around 72 hours.

50. A method as claimed in claim 34 for use in the sealing of underground utility mains, drains and pipework in industrial plants, or for use in sealing process links from waste settling tanks, wherein said waste settling tanks optionally contain radioactive waste.

51. A method as claimed in claim 50 wherein said container, said expandable polymeric material and said bonding resin are all radiation tolerant.

52. A method as claimed in claim 50 wherein said container comprises polyethylene or nylon, said expandable polymeric material comprises polyurethane foam and said bonding resin comprises an acrylic resin.

53. A method as claimed in claim 34 which additionally involves the use of access means and/or CCTV equipment.
